(19) United States
(12) Patent Application Publication
(10) Pub. No.: US 2026/0251271 A1
(43) Pub. Date: Aug. 27, 2026

(54) FLUID-ACTIVATED BIODEGRADABLE BIOLUMINESCENT GLOWING APPARATUS, COMPOSITIONS, KITS, METHODS, AND SYSTEMS

(71) Applicant: NYOKA DESIGN CORP., Courtenay (CA)

(72) Inventors: Daniel Adam Korvin, Nanaimo (CA); François Michel Proulx, Montreal (CA); Justin Atkin, Montreal (CA); Nicholas McGregor, Vancouver (CA)

(73) Assignee: NYOKA DESIGN CORP., Courtenay, BC (CA)

(21) Appl. No.: 18/879,222

(22) PCT Filed: Jun. 26, 2023
(86) PCT No.: PCT/CA2023/050885

§ 371 Date: Dec. 26, 2024

Related U.S. Application Data
(60) Provisional application No. 63/355,652, filed on Jun. 26, 2022.

(51) Int. Cl. F21K 2/06; C09J 129/04; C09J 133/08; F21V 21/088; F21V 21/40; F21Y 103/00

(52) U.S. Cl. CPC F21K 2/06; C09J 129/04; C09J 133/08; F21V 21/0885; F21V 21/406; F21Y 2103/00

(57) ABSTRACT

Aspects of fluid-activated biodegradable bioluminescent glowing apparatus, compositions, kits, methods, and systems are described. One aspect is a glowing apparatus. For example, the glowing apparatus may comprise an outer membrane defining a permeable container with an interior cavity and a light transmitting portion; and a bioluminescent composition that is contained in the interior cavity and operable to emit a bioluminescent light through the light transmitting portion when exposed to an activating fluid passed through the outer membrane and into the interior cavity. Related aspects of glowing compositions, kits, methods, and systems also are described.

### CROSS-REFERENCE TO RELATED APPLICATIONS

This application is a § 371 US National Stage Entry of International Patent Application No. PCT/CA2023/050885, filed Jun. 26, 2023, claiming the benefit of priority of US Provisional Patent Application No. 63/355,652, filed Jun. 26, 2022, the entireties of which are hereby incorporated by reference into this application.

### TECHNICAL FIELD

Aspects of this disclosure relate generally to fluid-activated biodegradable bioluminescent glowing apparatus, compositions, kits, methods, and systems. Some aspects activate when immersed in water.

### BACKGROUND

It is common for industrial fishing industry, marine Search and Rescue (SAR) operations, naval operations, and recreational divers to make extensive use of non-biodegradable glow sticks in underwater applications. Crack activated chemiluminescent glow sticks are the most common. Each year, these single-use plastic light-emitting devices release large amounts of non-biodegradable and often toxic chemical waste in rivers and oceans. Beyond the ecological impact of such ocean plastics and their degradation into micro plastics, recent research shows that through the food chain they can find their way into humans consuming ocean food and as such have become an international health concern.

A typical chemiluminescent glow stick is described in U.S. Pat. No. 3,774,022 (the '022 Patent). The '022 Patent describes a combined package comprising a chemiluminescent agent as the “fuel” and an activating agent therefor, wherein the fuel and activating agent are maintained in close association but separated from each other by a barrier medium to prevent interaction before the same is desired. When the barrier medium is ruptured, or otherwise broken down, either deliberately or unintentionally, a reaction occurs between the chemiluminescent agent and the activating agent with the emission of visible light without generating any appreciable amount of heat. Because chemiluminescent agents are usually toxic, their barrier mediums are typically impermeable to water, moisture vapour, and air, making them non-biodegradable and not recyclable. These single use plastic devices are nonetheless utilized in large numbers and commonly discarded in situ, often in rivers, streams, and ocean waters.

Bioluminescence has been utilized as a research tool and in novelty items. Examples are described in U.S. Pat. No. 6,436,682 (the '682 Patent), which discloses isolated and purified nucleic acid molecules that encode a luciferase from Renilla mulleri, Gaussia, Pleuromamma, and green fluorescent proteins from the genus Renilla and Ptilosarcus.

Improvements are required to avoid the ecological harms of non-biodegradable glowing items.

### SUMMARY

One aspect of this disclosure is a glowing apparatus. For example, the glowing apparatus may comprise an outer membrane defining a permeable container with an interior cavity, a light transmitting portion, and a permeable portion operable to pass an activating fluid into the interior cavity through the outer membrane; and a bioluminescent composition that is contained in the interior cavity and operable to emit a bioluminescent light through the light transmitting portion when exposed to the activating fluid the interior cavity. The permeable portion may comprise pores, openings, voids, and/or the like.

The outer membrane may comprise a biodegradable material. The biodegradable material may comprise a cellulose, regenerated cellulose, or cellulose acetate. The bioluminescent composition may emit the bioluminescent light for a reaction time when exposed to the activating fluid in the interior cavity; and the permeable container may biodegrade when exposed to the activating fluid for an exposure time greater than the reaction time. The activating fluid may comprise water; the bioluminescent composition may emit the bioluminescent light for a reaction time when exposed to the water in the interior cavity; and the permeable container may biodegrade when exposed to the water for an exposure time greater than the reaction time. The bioluminescent composition may be sealed in the interior cavity of the permeable container with a biodegradable adhesive. The biodegradable adhesive may comprise cyanoacrylate or PVA. The bioluminescent composition may be sealed in the interior cavity of the permeable container with a biodegradable thermoplastic.

The apparatus may be manufactured with a method comprising: melting an amount of biodegradable thermoplastic; placing the amount of biodegradable thermoplastic onto one or more surfaces of the permeable container; and pressing the one or more surfaces together to form a seal with the melted amount of biodegradable thermoplastic; allowing the melted amount of biodegradable thermoplastic to cool; and containing the bioluminescent composition in the interior cavity with the seal.

The permeable container or the bioluminescent composition may comprise a pigment. The bioluminescent composition may comprise microcapsules. The microcapsules may contain separate amounts of the bioluminescent composition. The microcapsules may be operable to release the separate amounts at different times after exposure to the activating fluid in a time-release manner. The bioluminescent composition may comprise bodies comprising a liposome, a micelle, a reverse micelle, a vesicle, a nanoemulsion, or a microemulsion. The bodies may contain separate amounts of the bioluminescent composition. The bodies may be operable to release the separate amounts at different times after exposure to the activating fluid in a time-release manner.

The apparatus may comprise a second outer membrane that surrounds the outer membrane. The second outer membrane may enclose the outer membrane and be breakable to expose the outer membrane to the activating fluid. The second outer membrane may comprise a waterproof, friable shell. The waterproof, friable shell may be breakable when exposed to a predetermined amount of water pressure. The apparatus may comprise a biodegradable frame operable to support the glowing apparatus from another object. The biodegradable frame may comprise a lamp frame comprising a handle operable to support the glowing apparatus. The apparatus may comprise an attachment element operable to attach the glowing apparatus to another object. The attachment element may comprise a clip, a hook, or an eyelet. The attachment element may comprise a laser-cut item, a water-cut item, or a 3D printed item. The attachment element may be operable to attach the glowing apparatus to a fishing line. The activating fluid may be aqueous or non-aqueous.

Another aspect of this disclosure is another glowing apparatus. For example, the glowing apparatus may comprise: an outer membrane defining an impermeable container comprising a port, a sidewall defining an interior cavity, and a light transmitting portion; a permeable membrane or plug operable to close the port; and a bioluminescent composition that is contained in the interior cavity and operable to emit a bioluminescent light through the light transmitting portion when exposed to an activating fluid passed through the permeable membrane and into the interior cavity. The permeable membrane or plug may be adhered to the sidewall with a biodegradable adhesive. The impermeable container may comprise a second port and the glowing apparatus may comprise a non-permeable membrane or plug operable to close the second port. The non-permeable membrane or plug may be biodegradable. The non-permeable membrane or plug may comprise a bio plug. The non-permeable membrane or plug may comprise an attachment element. The attachment element may comprise a clip, a hook, or an eyelet. The attachment element may be biodegradable. The attachment element may be attached to the outer membrane with a biodegradable clamp or a biodegradable adhesive. The outer membrane may comprise a biodegradable thermoplastic or a thermoformable biopolymer. The apparatus may comprise a waterproof, friable shell surrounding the outer membrane.

Another aspect of this disclosure is a glowing system. For example, the glowing system may comprise a glowing apparatus comprising an outer membrane defining a permeable container with an interior cavity, a light transmitting portion, and a permeable portion operable to pass an activating fluid into the interior cavity through the outer membrane; a bioluminescent composition that is contained in the interior cavity and operable to emit a bioluminescent light through the light transmitting portion when exposed to the activating fluid the interior cavity; a second outer membrane defining a light transmitting impermeable tube comprising a first port, a second port, and a sidewall defining a second interior cavity; a perforated plug that closes the first port and is selectively operable to admit the activating fluid into the light transmitting impermeable tube when the first port is closed; and a cap that seals the second port and is removable to allow for insertion of the glowing apparatus into the second interior cavity.

The second outer membrane may act as a protective sheath for the glowing apparatus and contain the activating fluid in the second interior cavity. The cap may be threaded onto the light transmitting impermeable tube. The cap may comprise a mesh or perforations. The system may comprise a gel that expands to block the mesh or perforations after being exposed to an amount of the activating fluid. The system may comprise an attachment element operable to attach the second outer membrane to another object. The attachment element may be made from a biodegradable material. The biodegradable material may comprise a biodegradable polymer, a bone or bone fragment, a metal, or wood. The attachment element may be operable to attach the apparatus to a person.

Another aspect of this disclosure is a glowing system. For example, the glowing system may comprise: a glowing apparatus comprising an outer membrane defining a permeable container with an interior cavity and a light transmitting portion; a bioluminescent composition that is contained in the interior cavity and operable to emit a bioluminescent light through the light transmitting portion when exposed to an activating fluid passed through the outer membrane and into the interior cavity; a light transmitting flexible polymeric element comprising a pouch; and a permeable object operable to contain the glowing apparatus in the pouch and admit the activating fluid into the pouch with the apparatus. The permeable object may comprise a natural or synthetic cloth. The permeable object may comprise a closure mechanism operable to receive and contain the glowing apparatus. The closure mechanism may comprise a button, an eyelet, a snap, or a zipper. The pouch may be formed out of a flexible clear polymer. The permeable object may comprise a natural or synthetic cloth and the flexible clear polymer is stitched to the natural or synthetic cloth to form the closure mechanism. The permeable object may comprise attachment loops.

Another aspect of this disclosure is a glowing composition. For example, the glowing composition may comprise: an enzyme, enzyme formula, or enzyme mixture; and a polymer capable of retaining an activating fluid under ambient conditions, the enzyme, enzyme formula, or enzyme mixture being mixable with the polymer to form a bioluminescent gel operable to emit a bioluminescent light when exposed to the activating fluid. The polymer may comprise a hydrophilic polymer. The activating fluid may comprise water. The polymer may define a permeable container.

Another aspect of this disclosure is another glowing apparatus. For example, the glowing apparatus may comprise an outer membrane defining an impermeable container with an interior cavity and a light transmitting portion; a perforation in the outer membrane; and a bioluminescent composition that is contained in the interior cavity and operable to emit a bioluminescent light through the light transmitting portion when exposed to an activating fluid passed through the perforation in the outer membrane and into the interior cavity.

The apparatus may comprise an attachment element operable to attach the outer membrane to another object. The attachment element may comprise a biodegradable material. The attachment element may comprise a clip, a hook, or an eyelet. The attachment element may comprise a biodegradable clip, hook, or eyelet. The attachment element may be operable to attach the glowing apparatus to a fishing line. The attachment element operable to attach the glowing apparatus to a fishing line may be biodegradable.

The outer membrane may comprise a biodegradable material. The biodegradable material may comprise a thermoplastic or a thermoformable biopolymer. The bioluminescent composition may emit the bioluminescent light for a reaction time when exposed to the activating fluid in the interior cavity; and the impermeable container may biodegrade when exposed to the activating fluid for an exposure time greater than the reaction time. The activating fluid may comprise water. The bioluminescent composition may emit the bioluminescent light for a reaction time when exposed to the water in the interior cavity; and the impermeable container may biodegrade when exposed to the water for an exposure time greater than the reaction time. The bioluminescent composition may be sealed in the interior cavity of the impermeable container with a biodegradable adhesive. The biodegradable adhesive may comprise cyanoacrylate or PVA.

Another aspect of this disclosure is another glowing apparatus. For example, the glowing apparatus may comprise an outer membrane defining a permeable container comprising an interior cavity, a light transmitting portion, and a permeable portion operable to pass an activating fluid into the interior cavity through the outer membrane, the interior cavity comprising a first chamber, a second chamber, and opening between the first and second chambers, and the permeable portion being operable to pass an activating fluid into the first chamber; a water-blocking gel that is located in the first chamber; a bioluminescent composition that is located in the second chamber and operable to emit a bioluminescent light through the light transmitting portion when exposed to the activating fluid passed in the second chamber; the water-blocking gel being movable by the activating fluid when passing into the second chamber through the opening and expandable to seal one of the permeable portion and the opening after being exposed to the activating fluid.

The apparatus may comprise an attachment element operable to attach the outer membrane to another object. The attachment element may comprise a biodegradable material. The attachment element may comprise a clip, a hook, or an eyelet. The clip, hook, or eyelet may be biodegradable. The attachment element may be operable to attach the glowing apparatus to a fishing line. The attachment element operable to attach the glowing apparatus to a fishing line may be biodegradable.

The outer membrane and the activating fluid entry chamber may comprise a biodegradable material. The biodegradable material may comprise a biodegradable thermoplastic or a thermoformable biopolymer. The bioluminescent composition may emit the bioluminescent light for a reaction time when exposed to the activating fluid in the interior cavity; and the impermeable container may biodegrade when exposed to the activating fluid for an exposure time greater than the reaction time. The activating fluid may comprise water. The bioluminescent composition may emit the bioluminescent light for a reaction time when exposed to the water in the interior cavity; and the impermeable container may biodegrade when exposed to the water for an exposure time greater than the reaction time. The bioluminescent composition may be sealed in the interior cavity of the impermeable container with a biodegradable adhesive. The biodegradable adhesive may comprise cyanoacrylate or PVA. Aspects of additional apparatus, compositions, kits, methods, and systems also are described.

### BRIEF DESCRIPTION OF THE DRAWINGS

The accompanying drawings, which are incorporated in and constitute part of this disclosure, illustrate exemplary aspects that, together with the written descriptions, explain the principles of this disclosure. Numerous aspects are particularly described, pointed out, and taught in the written descriptions. Some structural and operational aspects may be even better understood by referencing the written portions together with the accompanying drawings, of which:

FIG. 1 depicts a schematic of an exemplary glowing apparatus;

FIG. 2 depicts a schematic of FIG. 1 immersed in water;

FIG. 3 depicts a schematic of another exemplary glowing apparatus, shown as a glow stick;

FIG. 4 depicts a schematic of another exemplary glowing apparatus, shown as a lantern; and

FIG. 5 depicts a schematic of another exemplary glowing apparatus, shown as a pouch.

FIG. 6 depicts a schematic of another exemplary glowing apparatus, shown as an impermeable or low-permeability container with a perforation.

FIG. 7 depicts a schematic of another exemplary glowing apparatus, shown as an impermeable container with an activating fluid entry chamber.

FIG. 8 depicts a schematic of another exemplary glowing apparatus.

### DETAILED DESCRIPTION

Aspects of the present disclosure are not limited to the exemplary compositions, structural details, and component arrangements described in this description and shown in the accompanying drawings. Many aspects of this disclosure may be applicable to other aspects and/or capable of being practiced or carried out in various variants of use, including the examples described herein.

Throughout the written descriptions, specific details are set forth in order to provide a more thorough understanding to persons of ordinary skill in the art. For convenience and ease of description, some well-known elements may be described conceptually to avoid unnecessarily obscuring the focus of this disclosure. In this regard, the written descriptions and accompanying drawings should be interpreted as illustrative rather than restrictive, enabling rather than limiting.

Exemplary aspects of this disclosure reference fluid-activated biodegradable bioluminescent glowing apparatus, compositions, kits, methods, and systems. Some aspects are described with reference to a particular bioluminescent composition (e.g., one containing a luciferase enzyme) that is contained in a particular container (e.g., a permeable container), has a particular shape (e.g., an elongated shape), and/or is operable to emit a bioluminescent light through a light transmitting portion of the container when exposed to a particular activating fluid (e.g., water) in the container (e.g., through a permeable portion thereof). Some aspects are described with reference to particular biodegradable materials and/or disposal methods so that the bioluminescent composition emits light for a reaction time when exposed to the activating fluid (e.g., twenty-four hours or less) and the container biodegrades in situ when exposed to the activating fluid for an exposure time greater than the reaction time (e.g., over several weeks, depending on the fluid at its location). Unless claimed, these examples are provided for convenience and not intended to limit the present disclosure. Accordingly, the concepts described in this disclosure may be utilized with any glowing apparatus, compositions, kits, methods, and/or systems.

Reference axes may be described, including: a width axis X-X, a length axis Y-Y, and a depth axis Z-Z. Various aspects are described relative thereto. Axes X-X, Y-Y, and/or Z-Z may be utilized to describe relative arrangements of one element to another. For example, axis X-X may be non-parallel with axis Y-Y in some perspectives, meaning that they intersect at a non-parallel angle and/or are perpendicular with one another. The term “elongated” may describe any element having a dimension along one of axes X-X, Y-Y, or Z-Z that is longer in relation to another dimension along a non-parallel one of axes X-X, Y-Y, or Z-Z. Additional axes, movements, and forces also may be described with reference to axes X-X and Y-Y. These relative terms are provided for convenience and non-limiting unless claimed.

As utilized herein, inclusive terms such as “comprises,” “comprising,” “includes,” “including,” and variations thereof, are intended to cover a non-exclusive inclusion, such that a fluid-activated biodegradable bioluminescent glowing apparatus, composition, kit, method, system, or element thereof comprising a list of elements does not include only those elements but may include other elements not expressly listed and/or inherent thereto. Terms like “or” and “any” are not exclusive unless otherwise noted. Singular terms such as “a,” “an,” and “the” may include plural references unless the context clearly dictates otherwise. The gender or number (singular or plural) of some terms may be expressly stated in or inferred from this disclosure as the circumstances require. Unless stated otherwise, the term “exemplary” is utilized in the sense of “example,” rather than “ideal.”

Various terms of approximation may be utilized in this disclosure, including “approximately,” “generally,” and “about.” Unless stated otherwise, the term approximately means within 10% of a stated number or outcome, the term generally means “within most cases” or “usually,” and the term about may be applied to any recited range or value to denote an approximation of the range or value within a deviation that is known or expected in the art. Referential terms such as “herein”, “hereby”, “hereof”, “hereto”, “hereinbefore”, and “hereinafter”, and words of similar import, refer to this specification in its entirety and not to any particular paragraph, claim or other subdivision, unless otherwise specified.

Recitation of ranges of values herein are merely intended to serve as a shorthand method of referring individually to each separate value falling within the range, unless otherwise indicated herein; and each separate value is incorporated into the specification as if it were individually recited herein. Where a specific range of values is provided, it is understood that each intervening value, to the tenth of the unit of the lower limit unless the context clearly dictates otherwise, between the upper and lower limit of that range and any other stated or intervening value in that stated range, is included therein. All smaller sub ranges are also included. The upper and lower limits of these smaller ranges are also included therein, subject to any specifically excluded limit in the stated range.

Unless defined otherwise, all technical and scientific terms utilized herein have the same meaning as commonly understood by one of ordinary skill in the relevant art. Any methods and materials similar or equivalent to those described herein can also be utilized.

General aspects of this disclosure are now described. One exemplary aspect is a biodegradable light source that operates with bioluminescence, is rapidly deployable, and comprises a bioluminescent composition that is automatically activated when exposed to an activating fluid. Another exemplary aspect is a glowing apparatus with a permeable container operable to emit light through bioluminescence when exposed to the activating fluid, such as when selectively exposed, partially immersed, and/or fully immersed in the fluid. Different types of light-transmitting and permeable containers may be utilized, including those described below as a lantern, a pouch, a sachet, a stick, or the like.

The term “activating fluid” may comprise any aqueous or non-aqueous fluid operable with the bioluminescent composition(s) and/or permeable container(s) described herein. Many aspects are described with reference to water as the activating fluid, in which the generic term “water” may comprise any water-based liquid, including saline and like mixtures, and other organic liquids, such as an organic solvent. Any glowing apparatus described herein may be described as a permeable container with structural elements (e.g., beams, columns, walls, etc.) defining an outer membrane, an interior cavity surrounded by the outer membrane, and a permeable portion that allows the activating fluid to pass into the interior cavity through the outer membrane, in which the interior cavity contains a bioluminescent composition that is activated by the activating fluid.

Different types of activating fluids are described. For example, the activating fluid may comprise water and the permeable container may be described as a water-permeable container. Different types of bioluminescent compositions are described, including a powdered bioluminescent mixture that is activated once hydrated by the activating fluid. The structural elements of the permeable container may be formed from any biodegradable material that will be broken down over time by exposure to a natural environment, including the examples described herein. Different permeable structures also are described. For example, the permeable portion may comprise one or more perforations passing through the outer membrane. The permeable container may be formed from a biodegradable material, such as from a thin layer of cellulose, regenerated cellulose, and/or cellulose acetate (e.g., like a film) that is clear and biodegradable, such any portion of the permeable container may be described as permeable.

Different intensities of light may be emitted with different types of the activated bioluminescent compositions described herein, in which a lower threshold may be defined as still detectable to the naked eye at approximately 16 hours post activation with an ambient light of 10 lux or less.

In the examples described herein, because of osmotic pressure, the water may activate the glowing apparatus by (i) entering the internal cavity of the permeable container by passing through the permeable portion of the outer membrane, (ii) reacting with the bioluminescent composition contained in the interior cavity for a reaction time, and (iii) causing the activated bioluminescent composition to emit a bioluminescent light through all or a light transmitting portion of the permeable container during the reaction time while (iv) preventing the activated bioluminescent composition from rapidly flowing back out of the interior cavity through the permeable portion. Because it can be activated when exposed or submerged to the activating fluid (e.g., by tossing the glowing apparatus into a larger body of water), the usage of any glowing apparatus described herein may be simpler than the usage of traditional crack activated chemiluminescent glow sticks, which typically require additional activation steps such as the cracking. Moreover, when formed from biodegradable materials (e.g., a permeable biodegradable material that can biodegrade within a natural aquatic environment), the disposal of any glowing apparatus described herein also may be simpler because they can be safely disposed of in the water or other location to fully biodegrade in situ over time. Any glowing apparatus described herein may thus be described or claimed as being biodegradable, bioluminescent, and fluid activated.

Other types of activating fluids may be utilized for particular applications. For example, the bioluminescent composition may comprise luciferase and the activating fluid may comprise an organic solvent (e.g., like ethanol) comprising a dissolved amount of luciferin that may be passed through a permeable container to activate the luciferase, causing a luciferase catalysed bioluminescence reaction to proceed and emit light. In this example, if the organic solvent is a flammable liquid, then causing it to glow may help identify and contain leaks and/or spills of the flammable liquid in sensitive areas.

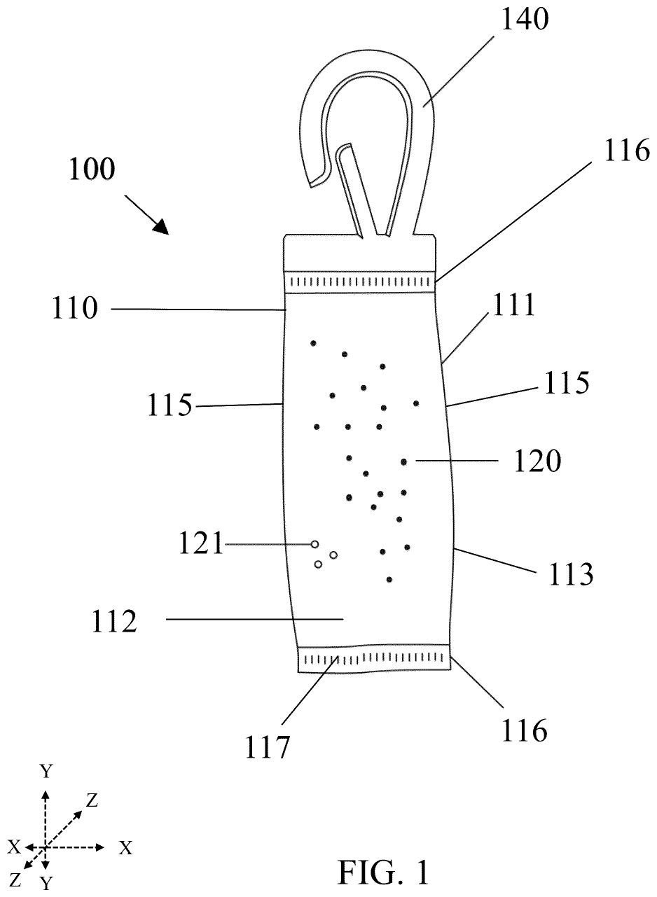

More particular aspects of this disclosure are now described with reference to an exemplary glowing apparatus 100 that may be biodegradable, bioluminescent, and/or fluid activated. As shown in FIG. 1, glowing apparatus 100 may comprise a permeable container 110 and a bioluminescent composition 120.

Permeable container 110 may comprise structures defining an outer membrane 111, an interior cavity 112, and a permeable portion 113. Bioluminescent composition 120 may be contained at least temporarily in interior cavity 112 and operable to emit a bioluminescent light through a light transmitting portion of outer membrane 111 when exposed to an activating fluid passed through permeable portion 113 of outer membrane 111 and into interior cavity 112 of permeable container 110.

As shown in FIG. 1, interior cavity 112 may be defined and bounded by outer membrane 111. For example, outer membrane 111 may comprise a film of biodegradable material that has been cut and shaped to define walls 115 of permeable container 110 surrounding interior cavity 112, ends 116 containing bioluminescent composition 120 in interior cavity 112, and a permeable portion 113 comprising one or more perforations forming a semipermeable membrane allowing the activating fluid to enter interior cavity 112. As shown in FIG. 1, interior cavity 112 of permeable container 110 may be sealed (e.g., glued shut) at either of ends 116 by a biodegradable or nonbiodegradable sealing element (e.g., an adhesive) 117.

Outer membrane 111 may comprise a thin layer of cellulose, regenerated cellulose, or cellulose acetate fluid-permeable material, such as film or filter membrane like those currently utilized for dialysis and water purification. Portions of outer membrane 111 may comprise a first layer comprising a cellulose, regenerated cellulose, or cellulose acetate material and second layer comprising a biodegradable thermoplastic, in which one of the first layer and the second layer is applied (e.g., coated) to the other so that said portions of outer membrane 111 are heat sealable and biodegradable (e.g., marine biodegradable). As shown in FIG. 1, edges of walls 115 and/or ends 116 may comprise portions of outer membrane 111 in which the second layer is applied to the first layer as an outer layer so that interior cavity 112 of permeable container 110 may be sealed by applying heat to the second layer with or without using a biodegradable or nonbiodegradable sealing element. In this example, permeable portion 113 may comprise the remaining portions of outer membrane 111.

Different examples of permeable portion 113 are described herein, including all or portions of outer membrane 111. Aspects of permeable portion 113 may be optimized to filter different sizes of molecules, including larger molecules, making it suitable for use with any type of activating fluid. As shown in FIG. 1, permeable portion 113 of outer membrane 111 may comprise one or more perforations sized to: (i) contain an amount of bioluminescent composition 120 in interior cavity 112; (ii) allow the activating fluid to enter interior cavity 112 for activation of enzyme(s) of the amount of bioluminescent composition 120 in interior cavity 112; and (iii) prevent the activated amount of bioluminescent composition 120 from rapidly flowing out of interior cavity 112 into the activating fluid. Permeable portion 113 may comprise different types of fluid-passing structures. For example, permeable portion 113 may comprise any combination of holes, pores, and/or voids passing through outer membrane 111 and into interior cavity 112 along any path. As a further example, outer membrane 111 may be described as a bag of any shape, such as a square shape, a rectangular, an irregular polygon (e.g., for implantation in a particular part of a body), a star shape (e.g., for decoration), a fish shape (e.g., for decoration and/or as a lure), or a worm shape (e.g., for decoration and/or as a lure); and permeable portion 113 may comprise any portion of the bag comprising one or more perforations.

Permeable portion 113 may comprise any number of perforations and/or other fluid-passing structures sized for particular applications. As shown in FIG. 1, if walls 115 are formed of a cellulose, regenerated cellulose, or cellulose acetate fluid-permeable material, such as film or filter membrane like those currently utilized for dialysis and water purification, then permeable portion 113 may be described as having pores extending into interior cavity 112 through outer membrane 111. The pores may have pore diameters approximate to a molecular weight cut-off (or “MWCO”) of between approximately 10 kDa and approximately 30 kDa, or an MWCO of between approximately 1kDa and 500kDa, depending upon type of biological composition 120 to be contained in interior cavity 112. As shown in FIG. 1, the pores of permeable portion 113 may allow the activating fluid to pass through outer membrane 111 and into interior cavity 112 while preventing the enzyme (e.g. luciferase) of bioluminescent composition 120 from rapidly escaping from interior cavity 112 due to osmotic pressures and the fluidic characteristics of biological composition 120 after activation.

Permeable membranes like outer membrane 111 have been developed and utilized for dialysis and water purification for a long time. One example is described in U.S. Pat. No. 6,632,366 (the '366 Patent), the entirety of which is hereby incorporated by reference into this application. The '366 Patent discloses a cellulose compound hollow fibre membrane having high mechanical strength and is hardly degraded by microorganisms, wherein a cellulose compound is comprised as a membrane material, the thickness of the membrane is 50 to 500 μm, a dense membrane surface having an average pore diameter of 0.001 to 0.05 μm exists on the internal and/or external surface thereof, the inside of the membrane is composed of a three-dimensional network-like porous structure having voids with an average pore diameter of 0.05 to 2 μm, and 70% by weight or more of the membrane material is cellulose acetate propionate or cellulose acetate butyrate. Outer membrane 111 and its counterparts may be similarly formed and/or have similar properties as the cellulose compounds described in the '366 Patent. For example, walls 115 and/or ends 116 of outer membrane 111 may have a thickness of between approximately 10 μm and approximately 100 μm. As a further example, outer membrane 111 may be made of a biodegradable material to have a wall thickness of between approximately 20 μm and approximately 40 μm; and a TUV Austria Marine composability certification indicating that permeable container 110 will degrade in 1-2 months.

Bioluminescent composition 120 may comprise different types of bioluminescent materials, mixtures, and/or solutions. As shown in FIG. 1, bioluminescent composition 120 may take the form of a bioluminescent powder comprising (a) at least one dried (e.g., freeze-dried or lyophilized) luciferase enzyme based on: (i) protein sequences derived from genera including: Photinus, Elateroidea, Renilla, Gaussia, Metridia, Photuris, Pyractomena, or the like, including any synthetic versions thereof; or (ii) luciferase enzyme variants commonly found in bacterial species, dinoflagellate species, fungal species, or the like, including any synthetic versions thereof; and (b) one or more of a substrate molecule(s), a cofactor(s), and/or an activator(s) operable with the luciferase enzyme(s) to produce light-emitting or bioluminescent reaction when exposed to the activating fluid “small molecules.” For example, when exposed to the activating fluid (e.g., when hydrated by an aqueous solution such as seawater) under appropriate conditions, such as with selective exposure and/or immersion (e.g., when submerged in the aqueous solution), bioluminescent composition 2 may produce a light-emitting or bioluminescent reaction for a predetermined reaction time.

Depending upon characteristics and quantity of bioluminescent composition 120, the light-emitting or bioluminescent reaction of bioluminescent composition 120 may occur approximately 5 to 15 minutes after exposure to and/or immersion in the activating fluid. The reaction time may last up to 16 hours or longer (e.g., 24+hours) depending on the needs of users such as industrial fishing industry, marine Search and Rescue (SAR) operations, naval operations, and recreational divers. In keeping with previous examples, the reaction time may be measured in hours whereas a degradation time of glowing apparatus 100 may be measured in months, a time longer than the reaction time but far less than the degradation time of crack-activated chemiluminescent glow sticks, which are typically measured in years.

Portions of bioluminescent composition 120 (e.g., small amounts of bioluminescent powder) may be contained separately to extend a run time of the bioluminescent reaction by continually exposing new amounts of bioluminescent composition 120 to the activating fluid over time. As shown in FIG. 1, separated portions of bioluminescent composition 120 may be contained in bodies or microcapsules 121 located in interior cavity 112 with the remainder of bioluminescent composition 120. In this example, each microcapsule 121 may comprise an outer wall operable to selectively cause the bioluminescent reaction when exposed to the activating fluid, such as in a time-released manner. For example, a first portion of microcapsules 121 may comprise walls with a first thickness and a second portion of microcapsules 121 may comprise walls with a second thickness that is greater than the first thickness so that first-released portions of bioluminescent composition 120 contained in the first portion of microcapsules 121 are activated sooner and second-released portions of bioluminescent composition 2 contained in the second portion of microcapsules 121 are activated later. Any number of different portions of microcapsules 121 may be similarly structured, the entirety of which may be mixed with the above-referenced bioluminescent powder to create an immediately produced bioluminescent light, a first later produced bioluminescent light, a second later produced bioluminescent light, and so on.

Aspects of bioluminescent composition 120 and/or microcapsules 121 may be optimized to modify the timing, intensity, and/or duration of the bioluminescent reaction. For example, the above-referenced powder may comprise an enzyme, an enzyme formula, and/or a mixture that may be combined with other components to generate a bioluminescent solution that may be described as comprising a liposome, a micelle, a reverse micelle, a vesicle, a nanoemulsion, or a microemulsion. For example, the other components may comprise molecules classed as surfactants, detergents, solvents, and/or emulsifiers, as well as other agents meant to manipulate properties including pH, osmolarity, chaotropicity, and other solution properties relevant to formation, stability, and function of bodies or microcapsules 121.

The enzyme(s) may be contained in one or more microcapsules 121 and activated when exposed to water passing through outer membrane 1 to contact, interact, and/or affect microcapsules 121, causing the enzyme(s) to escape from microcapsules 121. Alternatively, the enzyme(s) may be part of a mixture including one or more microcapsules 121 containing other molecules or reactants relevant to a bioluminescent reaction and activated when the mixture is exposed to water passing through outer membrane 111 and an outer layer of these bodies to slowly release the other molecules or reactants over time, creating a time-released reservoir of the other molecules or reactants.

The bioluminescent solution may be an aqueous solution, a non-aqueous solution, or some mixture of either solution type. In keeping with these examples, aspects of bioluminescent composition 120 and/or microcapsules 121 may prevent solution chemistry exterior to the liposome, micelle, reverse micelle, vesicle, nanoemulsion, or microemulsion from interfering with, or leading to an excessively deleterious effect on the intended performance or behaviour of the enzyme(s) with respect to emitted bioluminescence. Aspects of bioluminescent composition 120 and/or microcapsules 121 may be tuned to cause and/or maintain emissions of bioluminescent light when outer membrane 111 is exposed to particular environmental conditions, including acidic or basic pH conditions; certain solvent concentrations, such as ethanol or salt concentrations; reactive oxygen species; and/or other reactive agents, such as chemicals commonly used for chlorinating public and private swimming pools.

Bioluminescent composition 120 may comprise additives that modify and/or improve a performance of the enzyme(s), such as its brightness, duration, or stability. For example, the bodies described above may comprise a substrate such as luciferin and a luciferase enzyme that interacts to cause a desired emitted light inside the bodies. As a further example, the aforementioned bodies also may act as concentrators that increase the ratio of substrate to enzyme in order to cause a greater emission of light generated than would be emitted without said bodies in the same volume of the reaction media.

Aspects of bioluminescent composition 120 also may be optimized for particular applications. For example, the above-described powder may comprise an enzyme, an enzyme formula, and/or a mixture that may be combined with other components to generate a bioluminescent hydrogel. Other components may comprise hydrophilic polymers capable of retaining the activating fluid (e.g., water) under ambient conditions. For example, alginate may be used to generate a bioluminescent hydrogel. Alginate is readily available, robust, and has a reliable and predictable crosslinking behavior. Alginate is able to be crosslinked by covalent cations, typically a calcium. Alginate can be formed into a hydrogel with a calcium without the need for heat, thereby allowing heat-sensitive enzymes (e.g., luciferase) to be incorporated into the hydrogel. A hydrogel using alginate may comprise approximately 0.05% to approximately 2.0% weight by volume of enzyme, approximately 0.5% to approximately 2.0% weight by volume of small molecules, approximately 0.5% to approximately 5.0% weight by volume of alginate, and approximately 91% to approximately 98.95% weight by volume of an activating fluid. For further example, a hydrogel powder may comprise a ratio of approximately 140 parts enzyme, approximately 10-40 parts small molecules, and approximately 10-100 parts alginate. Other components capable of retaining the activating fluid may comprise polymers based on: Polyethylene glycol, Gelatin, Poly(lactic-co-glycolic acid), Poly(lactic acid), Poly(glycolic acid), collagen, fibrin, silk fibroin, chondroitin sulfate, xanthan gum, Carboxymethyl cellulose, Chitosan, hyaluronic acid, heparin, guar gum, ethylcellulose, keratin, pectin, agarose, plant cellulose; hydrophilic clay minerals such as: bentonite and kaolinite clays; and functionalized derivations and combinations of the above.

These other components may be mixed together with the enzyme, the enzyme formula, and/or the mixture and then adequately hydrated by the activating fluid so that the bioluminescent hydrogel may function like a hydrogel, a viscous gel, and/or a gelled solid that emits useful amounts of bioluminescent light. This mixture (e.g., including at least one or more hydrophilic polymers, at least one luciferase enzyme, and at least one luciferase substrate) may be in a liquid form having the appearance and texture of a hydrogel, a viscous gel, and/or a gelled solid that emits a useful bioluminescent light. Alternatively, the mixture may be in a dried form having the appearance and texture of a cake or powder and no visible luminescence. Upon addition of the activating fluid (e.g., water), the dried mixture may then take on the appearance and texture of a hydrogel, a viscous gel, and/or a gelled solid that emits bioluminescent light.

The bioluminescent hydrogel may thus be formed in interior cavity 112 and operable with permeable portion 113 to prevent the activated bioluminescent composition 120 from rapidly escaping by flowing back out of interior cavity 112 through permeable portion 113. For example, the bioluminescent hydrogel contained in interior cavity 112 may be operable to control the flow of water through outer membrane 111 and provide a protective effect to the enzyme. The bioluminescent hydrogel contained in interior cavity 112 may act as a reservoir that contains small molecules, ensuring a constant feed of additional small molecules for sustaining the reaction even if some of the small molecules escape.

When deployed as a bioluminescent hydrogel contained in interior cavity 112, bioluminescent composition 120 may be doped with a higher concentration of small molecules to ensure there is a longer supply of small molecules which feed the bioluminescent reaction. In keeping with above, for example, glowing apparatus 100 may be submerged in water so that components of bioluminescent composition 120 are mixed with the water to form a bioluminescent hydrogel that is contained in interior cavity 112 by fluid characteristics of the hydrogel, activated by a first amount water passing through permeable portion 113 to form the hydrogel, and sustained by amounts of water in the hydrogel.

The bioluminescent hydrogel may slow diffusion of compounds contained within or through the hydrogel. For example, small molecules without any container will: (i) diffuse quickly in an activating fluid; (ii) diffuse slower when contained in interior cavity 112; and (iii) will diffuse even slower when bioluminescent composition 120 is mixed with components to form the bioluminescent hydrogel. As described herein, the bioluminescent hydrogel may be used to affect the reaction time of bioluminescent composition 120 by favorably altering the kinetics of the reaction. This can be accomplished because a bioluminescent hydrogel will slow diffusion of small molecules through permeable portion 113.

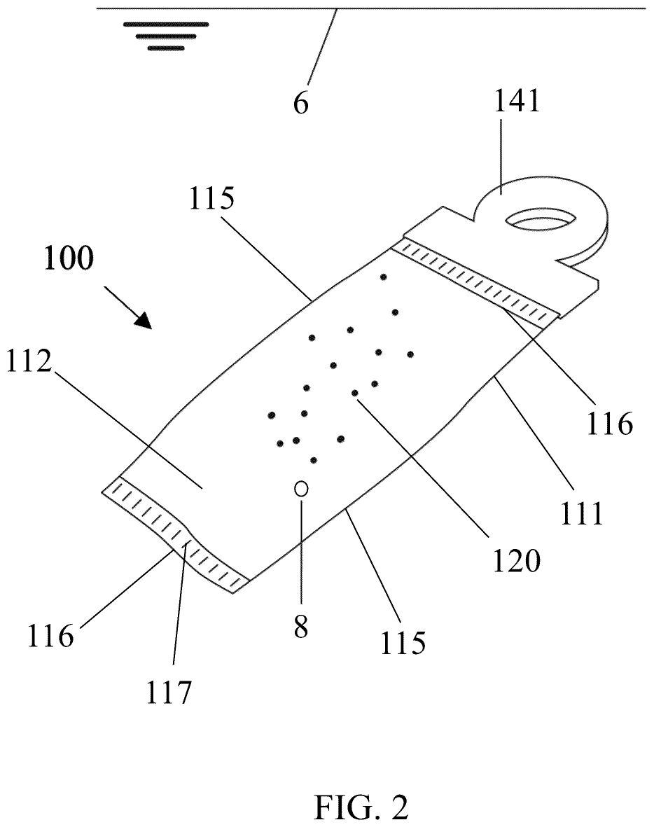

Different attachment elements may be attached to glowing apparatus 100 for storage and mounting. As shown in FIG. 1, a snap clip 140 may be affixed to one sealed end 116 of glowing apparatus 100. As also shown in FIG. 1, all or portions of outer membrane 111 may comprise a light transmitting portion of glowing apparatus 100. In keeping with above, the different attachment elements and/or ends 116 may be attached to one another with a biodegradable adhesive such as PVA, cyanoacrylate, and/or ureaformaldehyde. Certain formulations of PVA (e.g., like carpenter glues) can be made water resistant enough to maintain bond integrity for a duration of intended use for glowing apparatus 100. Different uses of glowing apparatus 100 for industrial fishing industry, marine SAR operations, naval operations, and recreational divers may require different durations of intended use, including those for fishing, diving, location, survival, and the like. Different formulations of outer membrane 111, the biodegradable adhesive, and/or other component of glowing apparatus 100 may thus be optimized for the different intended uses, such as for use in different environments. As shown in FIGS. 1 and 2, the biodegradable adhesive 117 may comprise a cyanoacrylate element operable to temporarily seal edge portions of outer membrane 111 by dissolving slowly over time in a manner consistent with its current use for affixing corals to stones by allowing the corals to bond with the stones before the cyanoacrylate element is dissolved.

An activated depiction of glowing apparatus 100 is shown in FIG. 2 as being fully immersed under a body of water 6 (i.e., the activating fluid in this example) to depict an exemplary application for industrial fishing industry, SAR operations, naval operations, and recreational divers. As shown in FIG. 2, permeable portion 113 of outer membrane 111 (e.g., such as all or a portion of walls 115) of glowing apparatus 100 may allow for the ingress of an amount of water 6 sufficient to activate the enzymes and bioluminescent composition 120 contained in interior cavity 112, resulting in activated (e.g., meaning glowing) bioluminescent composition 8. As also shown in FIG. 2, an eyelet 141 may extend through one sealed end of glowing apparatus 100 as an alternative to snap clip 140.

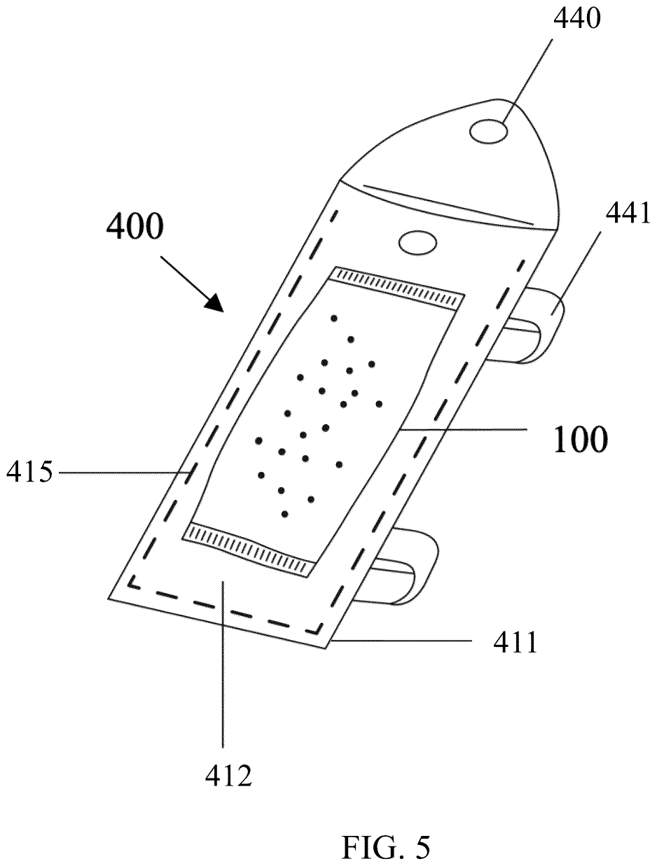

A full immersion of glowing apparatus 100 in body of water 6 is shown in FIG. 2 because that is common in marine environments where activated bioluminescent composition 8 may be commonly utilized for locating items or people in water 6. Partial immersions of outer membrane 111 also may be utilized, such as when a portion of outer membrane 111 is attachable to a life jacket (e.g., as shown in FIG. 5 and described below) and only partially submerged in water 6.

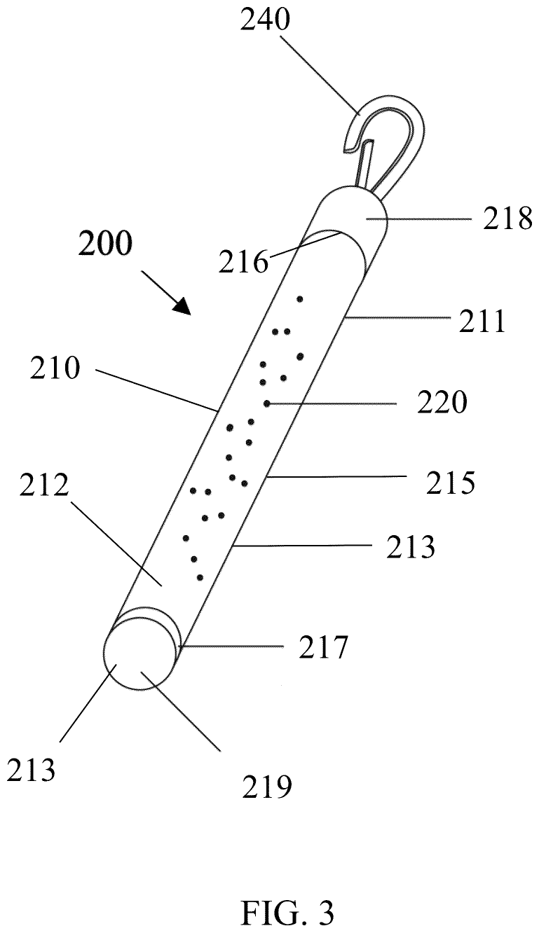

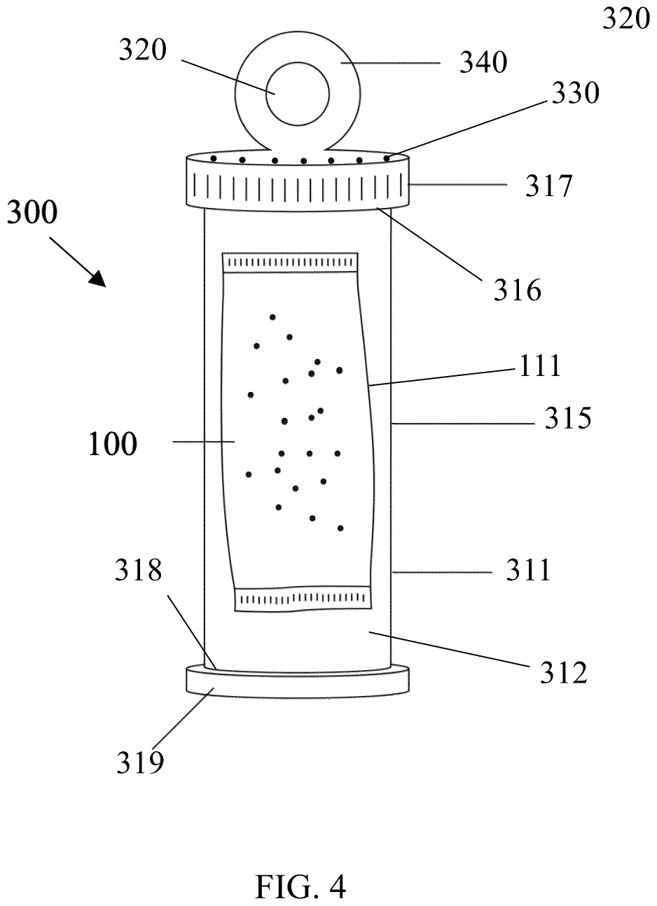

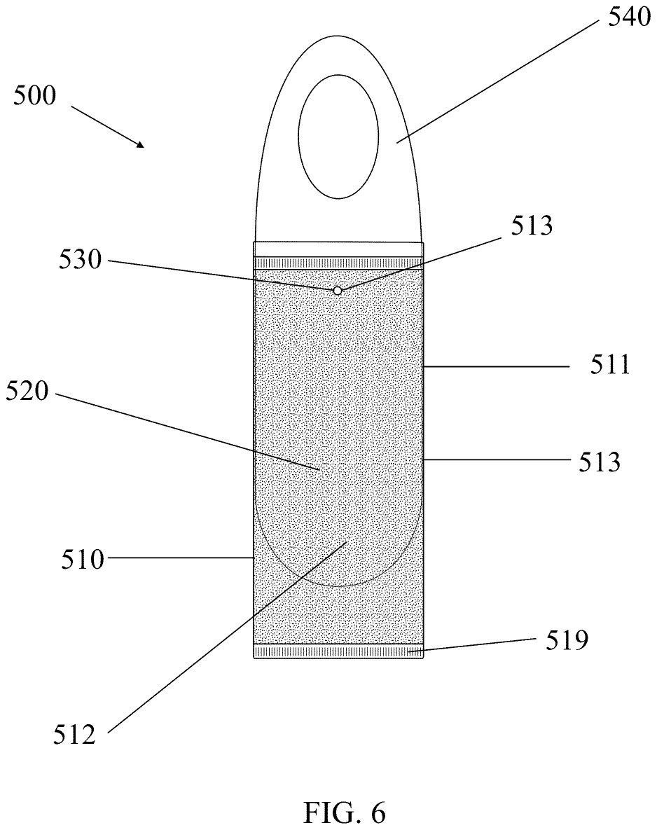

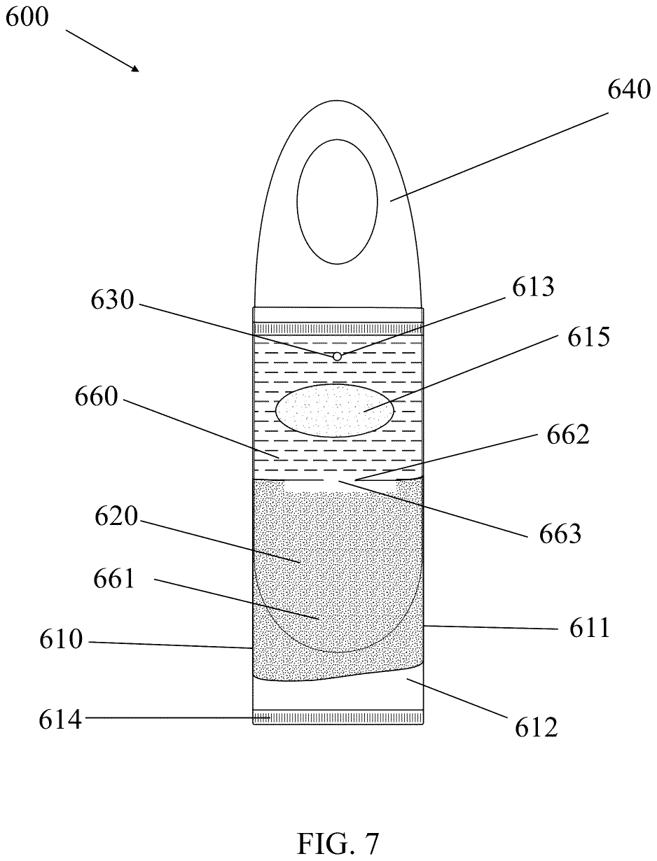

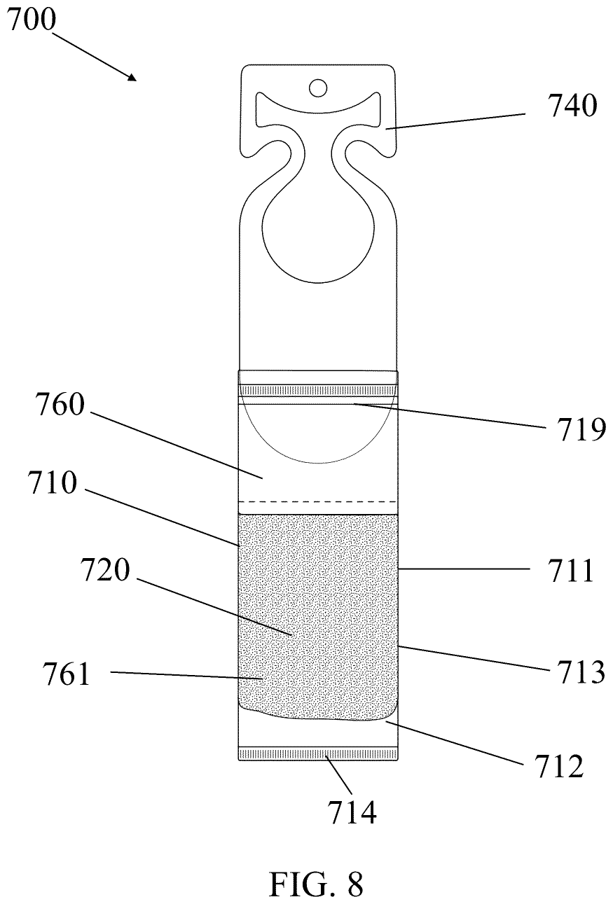

Additional aspects of this disclosure are now described with reference to a glowing apparatus 200 shown in FIG. 3, a glowing apparatus 300 shown in FIG. 4, a glowing apparatus 400 shown in FIG. 5, a glowing apparatus 500 shown in FIG. 6, a glowing apparatus 600 shown in FIG. 7, and a glowing apparatus 700 shown in FIG. 8. Aspects of glowing apparatus 200, 300, 400, 500, 600, and 700 may be like aspects of glowing apparatus 100, but with different reference numbers. Aspects of glowing apparatus 100 may be interchangeably combined with any aspects of glowing apparatus 200, 300, 400, 500, 600, and 700 and any obvious variations thereof, each combination and/or iteration being part of this disclosure. For example, aspects of glowing apparatus 200, 300, 400, 500, 600, and/or 700 may be interchangeably combined to assume different forms and/or be part of different systems.

As shown in FIG. 3, glowing apparatus 200 may comprise a biodegradable bioluminescent glow stick activated by immersion in an activating fluid (e.g., water). Glowing apparatus 200 may comprise a permeable container 210 and a bioluminescent composition 220.

Permeable container 210 may comprise structures defining an outer membrane 211, an interior cavity 212, and a permeable portion 213. Bioluminescent composition 220 may be contained in interior cavity 212 and operable to emit a bioluminescent light through a light transmitting portion of outer membrane 211 when bioluminescent composition 220 is exposed to an activating fluid passed through permeable portion 213 of outer membrane 211 and into interior cavity 212 of permeable container 210.

Permeable container 210 may comprise a tube sealed at one or both ends. As shown in FIG. 3, outer membrane 211 may comprise a sidewall 215, a first port 216, and a second port 217.

Sidewall 215 may be formed to define a tube, a sachet, or the like that is sealed at either end to define internal cavity 212 and contain bioluminescent composition 220. In this example, a bioluminescent light-generating reaction may be caused by exposing glowing apparatus 200 to the activating fluid, such as by submerging apparatus 200 in water. In keeping with above, sidewall 215 may comprise a biodegradable material like cellulose, regenerated cellulose, or cellulose acetate and interior cavity 212 may be sealed at ports 216, 217 with a biodegradable adhesive such as cyanoacrylate or PVA and/or a biodegradable thermoplastic (e.g., such as Polylactic Acid (PLA), Polyhydroxyalkanoates (PHA), and Polybutylene succinate (PBS)) that can be melted to form a seal. In this example, permeable portion 213 may comprise portions of sidewall 215 located between ports 216, 217 and the perforations of permeable portion 213 may be defined by cellular structures of the biodegradable material.

As shown in FIG. 3, bioluminescent composition 220 may be contained in interior cavity 112 between first port 216 and second port 217. First port 216 may be sealed with a first end 218 comprising a plug portion operable to seal one end of interior cavity 212 and an attachment element portion for attaching glowing apparatus 200 to another object, such as a releasable clip 240. Second port 217 may be sealed with a second end 219 shown as having a plug portion operable to seal the other end of interior cavity 112. As shown in FIG. 3, second end 219 may comprise a permeable membrane operable to pass amounts of activating fluid into 112, making it part of permeable portion 213 in complement to sidewall 215 and/or a substitute for the permeability of sidewall 215.

Aspects of bioluminescent composition 220 may be similar or identical to aspects of bioluminescent composition 120 described above, but within the 200 series of numbers.

As shown in FIG. 3, sidewall 215 of outer membrane 211 may alternatively be formed (e.g., via extrusion or molding) from a biodegradable material to have an impermeable tube with a light transmitting portion spanning between first port 216 and second port 217 to define interior cavity 212. In this alternative example, one or both of first end 218 and second end 219 may comprise a permeable membrane or plug sealing one or both of ports 216 and 217, such as with an interference fit and/or a water-resistant adhesive.

All or portions of outer membrane 211 may be made from a biodegradable thermoplastic or thermoformable biopolymer. An aluminized film or biopolymer water and air proof film may be utilized to seal water permeable membrane or plug during storage. First port 216 may be closed with the water permeable membrane or plug and second port 217 may be sealed with a non-permeable plug such as a biodegradable plug or “bio plug” like those described in U.S. patent application Ser. No. 17/054,153, the entirety of which is hereby incorporated by reference into this application. The non-permeable plug may comprise an attachment element that is attachable to other equipment or objects, such as a snap clip, eyelet, loop, or the like. For example, the attachment element (e.g., the snap clip, eyelet, loop, or the like) may be added to the outside of outer membrane 211 with a biodegradable adhesive, a clamp made of a biodegradable polymer, or the like. Sidewall 215 of outer membrane 211 may comprise a light transmitting portion of glowing apparatus 200 whereas plug 218 and/or 219 may not.

Similar to FIG. 4, glowing apparatus 200 may be enclosed within a second outer membrane (e.g., similar to membrane 311) such as a friable shell that is breakable to expose bioluminescent composition 220 to the activating fluid. For example, the second outer membrane may be a waterproof, friable shell that is attachable to a diver (e.g., with a snap clip) and breakable by the diver to selectively cause emission of the bioluminescent light, thereby allowing the diver to extend their dive time or illuminate more underwater areas. As a further example, the attachment element may comprise a laser-cut or a water-cut item such as a piece of marine plywood or balsa and/or a 3D printed item such as one printed from a biodegradable 3D printable polymer. Any glowing apparatus described herein may be similarly secured, glued, and/or clamped to a diver or other object with a different type of second outer membrane or like structure, such as a biodegradable frame comprising a snap clip, eyelet, and/or other attachment for attaching the glowing apparatus to another object.

As shown in FIG. 4, glowing apparatus 300 may comprise at least one glowing apparatus 100 sealed in a second outer membrane 311 having a first end 317 and a second end 319. Second outer membrane 311 may be made of a biodegradable material, allowing it to serve as a storage container and/or delivery vehicle for glowing apparatus 100. Different materials may be utilized. Outer membrane 111 of glowing apparatus 100 and second outer membrane 311 of glowing apparatus 300 may have different intended use times, such as for storage and/or when in deep water. As shown in FIG. 4, first end 317 may comprise an attachment element 340 operable to receive a line or other guiding element, such as eyelet extending therethrough, making it easily slid on and/or attachable to the line or other guiding element.

As shown in FIG. 4, glowing apparatus 300 may comprise a bioluminescent lantern in which: (i) outer membrane 311 comprises a light transmitting rigid impermeable tube comprising a sidewall 315 extending between a first port 316, and a second port 318 to define an interior cavity 312; (ii) first end 317 seals first port 316 and is selectively operable to allow the ingress of water into interior cavity 312; and (iii) second end 319 seals second port 318 and is removable to allow glowing apparatus 100 to be inserted and/or replaced within interior cavity 312 and/or to permit draining of interior cavity 312.

First end 317 and/or second end 319 may be threaded onto the tube of outer membrane 311. First end 317 may have a mesh or perforations 330 allowing the ingress of water. As shown in FIG. 4, first end 317 may comprise an attachment element 340, such a snap hook, D-clip, eyelet, or like structuring for attaching glowing apparatus 300 to other objects or equipment. As a further example, attachment element 340 also may be operable to attach apparatus 300 to another object with belt loops and cinching straps.

Aspects of first end 317 may be optimized to operate as a one-way valve that permits and amount of water to enter and be contained within interior cavity 312. As shown in FIG. 4, first end 317 may comprise perforations 330 operable to pass the amount of water into cavity 312. To prevent spilling water back out of perforations 330, an underside of first end 317 may comprise a water-blocking gel that is located proximate to perforations 330, such as in a chamber located there below. In this example, contact with the water-blocking gel will expand after being exposed to an amount of the water until it plugs perforations 330 (e.g., by expanding into them and/or filing the chamber), such that no more activating fluid will be able to pass into interior cavity 312. In this lantern example, second outer membrane 311 may act as a protective sheath for glowing apparatus 100 and its surrounding water for use in hazardous environments where there is a danger of outer membrane 111 being perforated.

As shown in FIG. 5, glowing apparatus 400 may comprise at least one glowing apparatus 100 contained in a second outer membrane 411 made from folding a biodegradable sheet into a pocket shape defining an interior cavity 412. Second outer membrane 411 and its interior cavity 412 may be formed by folding the biodegradable sheet, sealing sides 415 of the pocket shape with a biodegradable adhesive (e.g., as above), and enclosing glowing apparatus 100 in interior cavity 412 of the pocket shape.

As shown in FIG. 5, one end of second outer membrane 411 may comprise an eyelet 440 and a back surface of membrane 411 may comprise an attachment element 441 operable to removably attach glowing apparatus 400 to another object, such as a forearm, a lifejacket, or a fishing line.

As shown in FIG. 5, second outer membrane 411 may comprise a bioluminescent and/or biodegradable pouch manufactured to define a flexible, wearable pouch. A front side of second outer membrane 411 may comprise a light transmitting flexible element so that glowing apparatus 100 is visible when the pouch is worn. A remainder of the second outer membrane 411 may comprise a natural or synthetic cloth that is permeable to water, allowing glowing apparatus 100 be exposed to water when the pouch is submerged in the water along with the wearer. As shown in FIG. 5, the pouch may comprise a closure mechanism operable to contain glowing apparatus 100 within interior cavity 412, such as snap buttons, buttons, and eyelets, and zippers. In keeping with these examples, the flexible pouch may be formed out of a flexible clear polymer that can be sown on one end and attachable to the closure mechanism on the other end. As shown in FIG. 5, attachment element 441 may allow the pouch to be affixed to equipment or clothing, such as a life jacket.

As shown in FIG. 6, glowing apparatus 500 may comprise an impermeable or low-permeability biodegradable bioluminescent container activated by immersion in an activating fluid (e.g. water). Glowing apparatus 500 may comprise a permeable container 510, a bioluminescent composition 520, and an attachment element 540.

Aspects of permeable container 510 of glowing apparatus 500 may be identical to aspects of permeable container 110 of glowing apparatus 100, but within the 500 series of numbers. For example, permeable container 510 may similarly comprise structures defining an outer membrane 511, an interior cavity 512, and a permeable portion 513. Outer membrane 511 may comprise a light transmitting biodegradable material such as a biodegradable thermoplastic or thermoformable biopolymer. In keeping with above, membrane 511 may be sealed with a biodegradable adhesive such as cyanoacrylate, PVA, or a biodegradable thermoplastic that can be melted to form a seal 519. In contrast to above, as shown in FIG. 6, permeable portion 513 may comprise a perforation 530 shown as a hole that extends through outer membrane 511 at one end of permeable container 510. Aspects of bioluminescent composition 520 may be similar or identical to aspects of bioluminescent composition 120 described above, but within the 500 series of numbers. For example, bioluminescent composition 520 may be contained in interior cavity 512 and operable to emit a bioluminescent light through a light transmitting portion of outer membrane 511 when bioluminescent composition 520 is exposed to an activating fluid passed through perforation 530 and into interior cavity 512 of permeable container 510.

As shown in FIG. 6, attachment element 540 may comprise a polymeric beam structure. An upper portion of attachment element 540 may comprise different structures for using, storing, and mounting glowing apparatus 500, such as eyelet, hook, or similar structure. A back surface of permeable container 510 may be attached to a front surface of attachment element 540 with an adhesive.

All or portions of outer membrane 511 may define light-transmitting surfaces that are permeable or impermeable. For example, outer membrane 511 may have a permeability that is separate from that of permeable portion 513. As shown in FIG. 6, water may activate glowing apparatus 500 by (i) entering interior cavity 512 of permeable container 510 by passing through perforation 530, (ii) reacting with bioluminescent composition 520 contained in interior cavity 512 for a reaction time, and (iii) causing the activated bioluminescent composition 520 to emit a bioluminescent light through all or a light transmitting portion of permeable container 510 during the reaction time while (iv) preventing the activated bioluminescent composition 520 from rapidly flowing back out of interior cavity 512 because of the size, shape, and/or location of perforation 530 in complement to fluid changes in activated bioluminescent composition 520 after being exposed to the water.

As shown in FIG. 7, glowing apparatus 600 may comprise a biodegradable bioluminescent container activated by immersion in an activating fluid (e.g. water). Glowing apparatus 600 may comprise an impermeable container 610, a bioluminescent composition 620, and an attachment element 640.

Aspects of impermeable container 610 of glowing apparatus 600 may be identical or similar to aspects of permeable container 110 of glowing apparatus 100, but within the 600 series of numbers. For example, as shown in FIG. 7, impermeable container 610 may comprise structures defining an outer membrane 611, an interior cavity 612, and a permeable portion 613. In keeping with above, outer membrane 611 may comprise a light transmitting biodegradable material such as a biodegradable thermoplastic or thermoformable biopolymer; and be formed to define interior cavity 612 by any sealing means 614.

In contrast to above, interior cavity 612 may comprise a water entry chamber 660, a reaction chamber 661, and a dividing wall 662. As shown in FIG. 7, water entry chamber 660 may comprise an upper portion of interior cavity 612 and reaction chamber 661 may comprise a lower portion of interior cavity 612. Permeable portion 613 may comprise a perforation 630 extending into water entry chamber 660 through outer membrane 611. Dividing wall 662 may comprise a narrow gap opening 663 extending between water entry chamber 660 and reaction chamber 661, thereby placing the upper and lower portions of interior cavity 612 in fluid communication with another via narrow gap opening 663.

Bioluminescent composition 620 may be identical to bioluminescent composition 120 described above, but within the 600 series of numbers. For example, bioluminescent composition 620 may be contained in interior cavity 612 and operable to emit a bioluminescent light through a light transmitting portion of outer membrane 611 when bioluminescent composition 620 is exposed to an activating fluid passed into interior cavity 612. In contrast to above, a water-blocking gel (e.g., a hydrogel) 615 may be located in water entry chamber 660 and bioluminescent composition 620 may be located in reaction chamber 661 so that the water must flow through perforation 630, past the water-blocking gel 615 in water entry chamber 660, and through narrow gap opening 663 before entering reaction chamber 661.

As shown in FIG. 7, water may activate glowing apparatus 600 by (i) entering into water entry chamber 660 through perforation 630, (ii) interacting with the water-blocking gel 615 in the chamber 660 (e.g., such as pushing it aside) to form a flow path extending to narrow gap opening 663, (iii) pass through narrow gap opening 663 into reaction chamber 661, (iv) reacting with an amount of bioluminescent composition 620 contained in reaction chamber 661 for a reaction time, and (v) causing the activated bioluminescent composition 620 to emit a bioluminescent light through all or a light transmitting portion of impermeable container 610 during the reaction time while (iv) preventing the activated bioluminescent composition 620 from rapidly flowing back out of interior cavity 612 because of the size, shape, and/or location of narrow gap opening 663, the additional resistance imposed by the water-blocking gel in water entry chamber 660, the size, shape, and/or location of perforation 630 in complement to fluid changes in activated bioluminescent composition 620 after being exposed to the water.

Aspects of attachment element 640 of glowing apparatus 600 may be identical or similar to aspects attachment element 540 of glowing apparatus 500, but within the 600 series of numbers.

As shown in FIG. 8, glowing apparatus 700 may comprise a biodegradable bioluminescent container activated by immersion in an activating fluid (e.g. water). Glowing apparatus 700 may comprise a permeable container 710, a bioluminescent composition 720, and an attachment element 740.

Aspects of permeable container 710 of glowing apparatus 700 may be identical or similar to above, but within the 700 series of numbers. For example, as shown in FIG. 8, permeable container 710 may comprise structures defining an outer membrane 711, an interior cavity 712, and a permeable portion 713. In keeping with above, outer membrane 711 may comprise a light transmitting biodegradable material such as a biodegradable thermoplastic or thermoformable biopolymer; and be formed to define interior cavity 712 by any sealing means 714.

Similar to above, interior cavity 712 may comprise an upper chamber 760, a reaction chamber 761, and a dividing wall 762. In contrast to above, permeable portion 713 may comprise an end 719 of permeable container 710 comprising perforations, allowing water to enter interior cavity 712 from below.

Bioluminescent composition 720 may be identical to above, but within the 700 series of numbers. For example, bioluminescent composition 720 may be contained in reaction chamber 761 and operable to emit a bioluminescent light through a light transmitting portion of outer membrane 711 when bioluminescent composition 720 is exposed to an activating fluid passed into reaction chamber 761 through permeable portion 730. Upper chamber 760 may be sealed off from reaction chamber 761. For example, a desired reaction time for glowing apparatus 700 may be adjusted by modifying a size of upper chamber 760 relative to reactive 761 and thus the amount of bioluminescent composition 720. Alternatively, a reaction-sustaining substance may (e.g., a bioluminescent hydrogel like those described above) may be located in upper chamber 760 and operable to flow into reaction chamber 761 after bioluminescent composition 720 has been activated, such as through an opening between chambers 760 and 761 (e.g., like narrow gap opening 663).

As shown in FIG. 7, water may activate glowing apparatus 700 by (i) entering into reaction chamber 761 through permeable portion 713, (ii) reacting with an amount of bioluminescent composition 720 contained in reaction chamber 761 for a reaction time, and (iii) causing the activated bioluminescent composition 720 to emit a bioluminescent light through all or a light transmitting portion of permeable container 710 during the reaction time while (iv) preventing the activated bioluminescent composition 720 from rapidly flowing back out of reaction chamber 761 because of the size, shape, and/or structures of permeable portion 713 in complement to fluid changes in activated bioluminescent composition 720 after being exposed to the water.

Aspects of attachment element 740 of glowing apparatus 700 may be identical or similar to above, but within the 700 series of numbers. In contrast to above, as shown in FIG. 8, attachment element 740 may comprise a flat shape forming hook shapes and/or openings operable for attaching glowing apparatus 700 to another item by traditional means. As shown in FIG. 8, attachment element 740 may be 3D printed from a biodegradable polymer to have hook shapes on each side for attachment to a fishing line.

Different types of glowing apparatus, compositions, methods, and systems have been described herein, including several examples of fluid-activated, biodegradable, and/or bioluminescent glowing apparatus, compositions, methods, and systems. Any aspects of glowing apparatus 100, 200, 300, 400, 500, 600, and/or 700 described herein may be sold separately as part of a method, a kit, or a system including a plurality of such apparatus plus instructions and related accessories.

In any form described herein, bioluminescent composition 120 may be easily integrated into glowing apparatus 100, 200, 300, 400, 500, 600, and/or 700 and similar products, including marine implementations, medical devices, research aids, safety devices, and/or sporting accessories. Because of their biocompatible nature, bioluminescent composition 120 also may be integrated into products that are wearable on the body and/or placed directly against the skin, including any accessories, apparel, bioluminescent body paints, cosmetics, personal lubricants, and/or intimacy products. Because some of these applications may not require a permeable container for delivery, it is contemplated that aspects of bioluminescent compositions 120 described herein, such as the various types of bioluminescent hydrogels described herein, may be claimed separately as independent inventions.

While principles of the present disclosure are described herein with reference to illustrative aspects, the disclosure is not limited thereto. Those having ordinary skill in the art and access to the teachings provided herein will recognize additional modifications, applications, aspects, and substitution of equivalents all fall in the scope of the aspects described herein. Accordingly, the present disclosure is not to be considered as limited by the foregoing description.

1. A glowing apparatus comprising:
an outer membrane defining a permeable container comprising an interior cavity, a light transmitting portion, and a permeable portion operable to pass an activating fluid into the interior cavity through the outer membrane; and
a bioluminescent composition that is contained in the interior cavity and operable to emit a bioluminescent light through the light transmitting portion when exposed to the activating fluid in the interior cavity.

2. The apparatus of claim 1, wherein the outer membrane comprises a biodegradable material.

3. The apparatus of claim 2, wherein the biodegradable material comprises a cellulose, regenerated cellulose, or cellulose acetate.

4. The apparatus of claim 1, wherein:
the bioluminescent composition emits the bioluminescent light for a reaction time when exposed to the activating fluid in the interior cavity; and
the permeable container biodegrades when exposed to the activating fluid for an exposure time greater than the reaction time.

5. The apparatus of claim 1, wherein:
the activating fluid comprises water;
the bioluminescent composition emits the bioluminescent light for a reaction time when exposed to the water in the interior cavity; and
the permeable container biodegrades when exposed to the water for an exposure time greater than the reaction time.

6. The apparatus of claim 5, wherein the bioluminescent composition is sealed in the interior cavity of the permeable container with a biodegradable adhesive.

7. The apparatus of claim 6, wherein the biodegradable adhesive comprises cyanoacrylate or PVA.

8. The apparatus of claim 1, wherein the bioluminescent composition is sealed in the interior cavity of the permeable container with a biodegradable thermoplastic.

9. A method of manufacturing the apparatus of claim 8, the method comprising:
melting an amount of biodegradable thermoplastic;
placing the amount of biodegradable thermoplastic onto one or more surfaces of the permeable container; and
pressing the one or more surfaces together to form a seal with the melted amount of biodegradable thermoplastic;
allowing the melted amount of biodegradable thermoplastic to cool; and
containing the bioluminescent composition in the interior cavity with the seal.

10. The apparatus of claim 1, wherein the permeable container or the bioluminescent composition comprise a pigment.

11. The apparatus claim 1, wherein the bioluminescent composition comprises microcapsules.

12. The apparatus of claim 11, wherein the microcapsules contain separate amounts of the bioluminescent composition.

13. The apparatus of claim 12, wherein the microcapsules are operable to release the separate amounts at different times after exposure to the activating fluid in a time-release manner.

14. The apparatus claim 1, wherein the bioluminescent composition comprises bodies comprising a liposome, a micelle, a reverse micelle, a vesicle, a nanoemulsion, or a microemulsion.

15. The apparatus of claim 14, wherein the bodies contain separate amounts of the bioluminescent composition.

16. The apparatus of claim 15, wherein the bodies are operable to release the separate amounts at different times after exposure to the activating fluid in a time-release manner.

17. The apparatus of claim 1, comprising a second outer membrane that surrounds the outer membrane.

18. The apparatus of claim 17, wherein the second outer membrane encloses the outer membrane and is breakable to expose the outer membrane to the activating fluid.

19. The apparatus of claim 18, wherein the second outer membrane comprises a waterproof, friable shell.

20. The apparatus of claim 19, wherein the waterproof, friable shell is breakable when exposed to a predetermined amount of water pressure.

21. The apparatus of claim 1, comprising a biodegradable frame operable to support the glowing apparatus from another object.

22. The apparatus of claim 1, wherein the biodegradable frame comprises a lamp frame comprising a handle operable to support the glowing apparatus.

23. The apparatus of claim 1, comprising an attachment element operable to attach the glowing apparatus to another object.

24. The apparatus of claim 23, wherein the attachment element comprises a clip, a hook, or an eyelet.

25. The apparatus of claim 23, wherein the attachment element comprises a laser-cut item, a water-cut item, or a 3D printed item.

26. The apparatus of claim 23, wherein the attachment element is operable to attach the glowing apparatus to a fishing line.

27. The apparatus of claim 1, wherein the activating fluid is non-aqueous.

28. A glowing apparatus comprising:
an outer membrane defining an impermeable container comprising a port, a sidewall defining an interior cavity, and a light transmitting portion;
a permeable membrane or plug operable to close the port; and
a bioluminescent composition that is contained in the interior cavity and operable to emit a bioluminescent light through the light transmitting portion when exposed to an activating fluid passed through the permeable membrane and into the interior cavity.

29. The apparatus of claim 28, wherein the permeable membrane or plug is adhered to the sidewall with a biodegradable adhesive.

30. The apparatus of claim 28, wherein the impermeable container comprises a second port and the glowing apparatus comprises a non-permeable membrane or plug operable to close the second port.

31. The apparatus of claim 30, wherein the non-permeable membrane or plug is biodegradable.

32. The apparatus of claim 30, wherein the non-permeable membrane or plug comprises a bio plug.

33. The apparatus of claim 30, wherein the non-permeable membrane or plug comprises a biodegradable attachment element.

34. The apparatus of claim 33, wherein the biodegradable attachment element comprises a clip, a hook, or an eyelet.

35. The apparatus of claim 33, wherein the attachment element is attached to the outer membrane with a clamp or an adhesive.

36. The apparatus of claim 28, wherein the outer membrane comprises a biodegradable thermoplastic or a thermoformable biopolymer.

37. The apparatus of claim 28, comprising a waterproof, friable shell surrounding the outer membrane.

38. A glowing system:
the apparatus of claim 1;
a second outer membrane defining a light transmitting impermeable tube comprising a first port, a second port, and a sidewall defining a second interior cavity;
a perforated plug that closes the first port and is selectively operable to admit the activating fluid into the light transmitting impermeable tube when the first port is closed; and
a cap that seals the second port and is removable to allow for insertion of the glowing apparatus of claim 1 into the second interior cavity.

39. The system of claim 38, wherein the second outer membrane acts as a protective sheath for the glowing apparatus of claim 1 and contains the activating fluid in the second interior cavity.

40. The system of claim 38, wherein the cap is threaded onto the light transmitting impermeable tube.

41. The system of claim 39, wherein the cap comprises a mesh or perforations.

42. The system of claim 41, comprising a gel that expands to block the mesh or perforations after being exposed to an amount of the activating fluid.

43. The system of claim 38, wherein the cap comprises an attachment element operable to attach the second outer membrane to another object.

44. The system of claim 43, wherein the attachment element is made from a biodegradable material.

45. The system of claim 44, wherein the biodegradable material comprises a biodegradable polymer, a bone or bone fragment, a metal, or wood.

46. The system of claim 38, wherein the attachment element is operable to attach the apparatus of claim 1 to a person.

47. A glowing system comprising:
the apparatus of claim 1;
a light transmitting flexible polymeric element comprising a pouch; and
a permeable object operable to contain the apparatus of claim 1 in the pouch and admit the activating fluid into the pouch with the apparatus of claim 1.

48. The system of claim 47, wherein the permeable object comprises a natural or synthetic cloth.

49. The system of claim 47, wherein the permeable object comprises a closure mechanism operable to receive and contain the apparatus of claim 1.

50. The system of claim 47, wherein the closure mechanism comprises a button, an eyelet, a snap, or a zipper.

51. The system of claim 47, wherein the pouch is formed out of a flexible clear polymer.

52. The system of claim 47, wherein the permeable object comprises a natural or synthetic cloth and the flexible clear polymer is stitched to the natural or synthetic cloth to form the closure mechanism.

53. The system of claim 47, wherein the permeable object comprises attachment loops.

54. A glowing composition comprising:
an enzyme, enzyme formula, or enzyme mixture; and
a polymer capable of retaining an activating fluid under ambient conditions,
the enzyme, enzyme formula, or enzyme mixture being mixable with the polymer to form a bioluminescent gel operable to emit a bioluminescent light when exposed to the activating fluid.

55. The composition of claim 54, wherein the polymer comprises a hydrophilic polymer and the activating fluid comprises water.

56. The composition of claim 54, wherein the polymer is formable to define a permeable container.

57. A glowing apparatus comprising:
an outer membrane defining an impermeable container with an interior cavity and a light transmitting portion;
a perforation in the outer membrane; and
a bioluminescent composition that is contained in the interior cavity and operable to emit a bioluminescent light through the light transmitting portion when exposed to an activating fluid passed through the perforation in the outer membrane and into the interior cavity.

58. The apparatus of claim 57, comprising an attachment element operable to attach the outer membrane to another object.

59. The apparatus of claim 58, wherein the attachment element comprises a biodegradable material.

60. The apparatus of claim 58 or 59, wherein the attachment element comprises a clip, a hook, or an eyelet.

61. The apparatus of claim 58 or 59, wherein the attachment element is operable to attach the glowing apparatus to a fishing line.

62. The apparatus of claim 57, wherein the outer membrane comprises a biodegradable material.

63. The apparatus of claim 62, wherein the biodegradable material comprises a biodegradable thermoplastic or a thermoformable biopolymer.

64. The apparatus of claim 57, wherein:
the bioluminescent composition emits the bioluminescent light for a reaction time when exposed to the activating fluid in the interior cavity; and
the impermeable container biodegrades when exposed to the activating fluid for an exposure time greater than the reaction time.

65. The apparatus of claim 1, wherein:
the activating fluid comprises water;
the bioluminescent composition emits the bioluminescent light for a reaction time when exposed to the water in the interior cavity; and
the impermeable container biodegrades when exposed to the water for an exposure time greater than the reaction time.

66. The apparatus of claim 57, wherein the bioluminescent composition is sealed in the interior cavity of the impermeable container with a biodegradable adhesive.

67. The apparatus of claim 66, wherein the biodegradable adhesive comprises cyanoacrylate or PVA.

68. A glowing apparatus comprising:
an outer membrane defining a permeable container comprising an interior cavity, a light transmitting portion, and a permeable portion operable to pass an activating fluid into the interior cavity through the outer membrane, the interior cavity comprising a first chamber, a second chamber, and opening between the first and second chambers, and the permeable portion being operable to pass an activating fluid into the first chamber;
a water-blocking gel that is located in the first chamber;
a bioluminescent composition that is located in the second chamber and operable to emit a bioluminescent light through the light transmitting portion when exposed to the activating fluid passed in the second chamber;
the water-blocking gel being movable by the activating fluid when passing into the second chamber through the opening and expandable to seal one of the permeable portion and the opening after being exposed to the activating fluid.

69. The apparatus of claim 68, comprising an attachment element operable to attach the outer membrane to another object.

70. The apparatus of claim 68, wherein the attachment element comprises a biodegradable material.

71. The apparatus of claim 69 or 70, wherein the attachment element comprises a clip, a hook, or an eyelet.

72. The apparatus of claim 69 or 70, wherein the attachment element is operable to attach the glowing apparatus to a fishing line.

73. The apparatus of claim 68, wherein the outer membrane comprises a biodegradable material.

74. The apparatus of claim 73, wherein the biodegradable material comprises a biodegradable thermoplastic or a thermoformable biopolymer.

75. The apparatus of claim 57, wherein:
the bioluminescent composition emits the bioluminescent light for a reaction time when exposed to the activating fluid in the interior cavity; and
the impermeable container biodegrades when exposed to the activating fluid for an exposure time greater than the reaction time.

76. The apparatus of claim 1, wherein:
the activating fluid comprises water;
the bioluminescent composition emits the bioluminescent light for a reaction time when exposed to the water in the interior cavity; and
the impermeable container biodegrades when exposed to the water for an exposure time greater than the reaction time.

77. The apparatus of claim 68, wherein the bioluminescent composition is sealed in the interior cavity of the impermeable container with a biodegradable adhesive.

78. The apparatus of claim 77, wherein the biodegradable adhesive comprises cyanoacrylate or PVA.
